(19) United States
(12) Patent Application Publication
(10) Pub. No.: US 2003/0048493 A1
(43) Pub. Date: Mar. 13, 2003

(54) Two sensor quantitative low-light color camera

(76) Inventors: Brian Decoursey Pontifex, Surrey (CA); Alexander Carlos Fernandes, Port Coquitlam (CA); Martin Lewis Furse, Vancouver (CA)

Correspondence Address: OYEN WIGGS GREEN & MUTALA, 480 - 601 W. CORDOVA STREET, VANCOUVER, BC, V6B 1G1 99915, CA

(21) Appl. No.: 10/153,679

(22) Filed: May 24, 2002

Related U.S. Application Data
(60) Provisional application No. 60/317,923, filed on Sep. 10, 2001.

(51) Int. Cl. H04N 1/46

(52) U.S. Cl. 358/514

(57) ABSTRACT

A high sensitivity monochrome image sensor optically coupled to receive a first sub-beam having a first light intensity produces a plurality of monochrome image pixels representative of an imaged object. A color image sensor optically coupled to receive a second sub-beam having a second light intensity produces a plurality of color image pixels representative of the imaged object. The monochrome sensor has a higher sensitivity than the color sensor. The first light intensity exceeds the second light intensity (i.e., the ratio of the first sub-beam's light intensity to that of the second sub-beam is between about 70:30 and 80:20). Separate control circuits are provided for each sensor, allowing each sensor to be operated selectably independently of the other.

### REFERENCE TO RELATED APPLICATION

This application claims the benefit of U.S. Provisional Patent Application Ser. No. 60/317,923 filed Sep. 10, 2001.

### TECHNICAL FIELD

This invention relates to digital imaging, specifically quantitative imaging for computer analysis of digital images.

### BACKGROUND

The prior art has evolved several methods of acquiring color images with solid-state cameras. For example, in the so-called “mosaic color” method, one of a red, green, or blue primary color filter is applied directly to each one of the pixels of a solid-state image sensor, giving each pixel a red, green, or blue spectral absorption characteristic. This method is attractive in many cases because of its relatively low cost and high image acquisition speed characteristics. However, the mosaic color method's light sensitivity and spatial resolution characteristics are reduced by the filters. The filters' fixed wavelength characteristics also restrict the ability to image specific color bands.

The “3-chip color” prior art method splits an input light beam into three sub-beams; passes each sub-beam through a distinct color filter (i.e. red, green, or blue); and couples the output of each filter to one of three monochrome image sensors. The 3-chip color method offers high image acquisition speed and high spatial resolution, but at a relatively high cost, since three image sensors (typically the single most expensive component in a solid-state camera) are required. The 3-chip color method also restricts the ability to image specific color bands, since the filters again have fixed wavelength characteristics.

Another prior art technique is to place a filter wheel or electrically tunable color filter in the light path of a monochrome image sensor. This method offers high spatial resolution, relatively low cost, and flexible selection of color bandwidths. However, image acquisition speed is significantly reduced, since a separate image must be acquired for each filter wheel position and a minimum of three images (i.e. red, green, and blue) must be acquired to produce a full color image. This method has the added disadvantage of reduced sensitivity if an electrically tunable color filter is used, since such filters attenuate a significant amount of the input light.

A fourth prior art solid-state camera color image acquisition method uses two image sensors: one monochrome image sensor and one mosaic color image sensor. This method has been used in tube type cameras as disclosed in U.S. Pat. No. 3,934,266 Shinozaki et al. U.S. Pat. No. 4,166,280 Poole discloses a similar method using a lower resolution color solid-state sensor in combination with a higher resolution monochrome tube sensor to generate the luminance signal. U.S. Pat. Nos. 4,281,339 Morishita et al; 4,746,972 Takanashi et al; 4,823,186 Muramatsu; 4,876,591 Muramatsu; 5,379,069 Tani; and, 5,852,502 Beckett further exemplify use of a monochrome solid-state sensor in combination with at least one lower resolution color sensor. In general, these prior art techniques maximize the spatial resolution of the luminance or monochrome signal relative to the chrominance or color signal. However, in order to achieve higher spatial resolution with the same optical interface, one must reduce sensitivity to light and photometric resolution or signal-to-noise ratio. Such reduction may be acceptable in qualitative imaging devices such as mass consumer market cameras which rely on the human eye to assess image quality, but is unacceptable in quantitative imaging devices used for computerized digital image analysis. The human eye has relatively good spatial resolution, but relatively poor photometric resolution; whereas in quantitative imaging (so-called “machine vision”) applications, light sensitivity and photometric resolution are of primary importance, particularly under low-light conditions.

### SUMMARY OF INVENTION

In accordance with the invention, a quantitative color image is produced by providing first and second light sub-beams representative of an imaged object, such that the first sub-beam's light intensity exceeding the second sub-beam's light intensity. Preferably, the ratio of the first sub-beam's light intensity to that of the second sub-beam is between about 70:30 and 80:20. The first sub-beam is processed at a relatively high sensitivity to produce a first plurality of monochrome image pixels representative of the imaged object. The second sub-beam is processed at lower sensitivity to produce a second plurality of color image pixels representative of the imaged object.

The first sub-beam is preferably processed at maximal signal-to-noise ratio so that the monochrome image pixels are maximally representative of the imaged object. Advantageously, the first sub-beam can be processed selectably and independently of the processing of the second sub-beam.

### BRIEF DESCRIPTION OF DRAWINGS

FIG. 1 is a block diagram of the optical front end and associated electronics of a solid-state camera quantitative color image acquisition system in accordance with the invention.

FIGS. 2a and 2b schematically depict coupling of a monochrome image sensor pixel to a group of color image sensor pixels in a primary (FIG. 2a) and in a complementary (FIG. 2b) quantitative color image acquisition system in accordance with the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

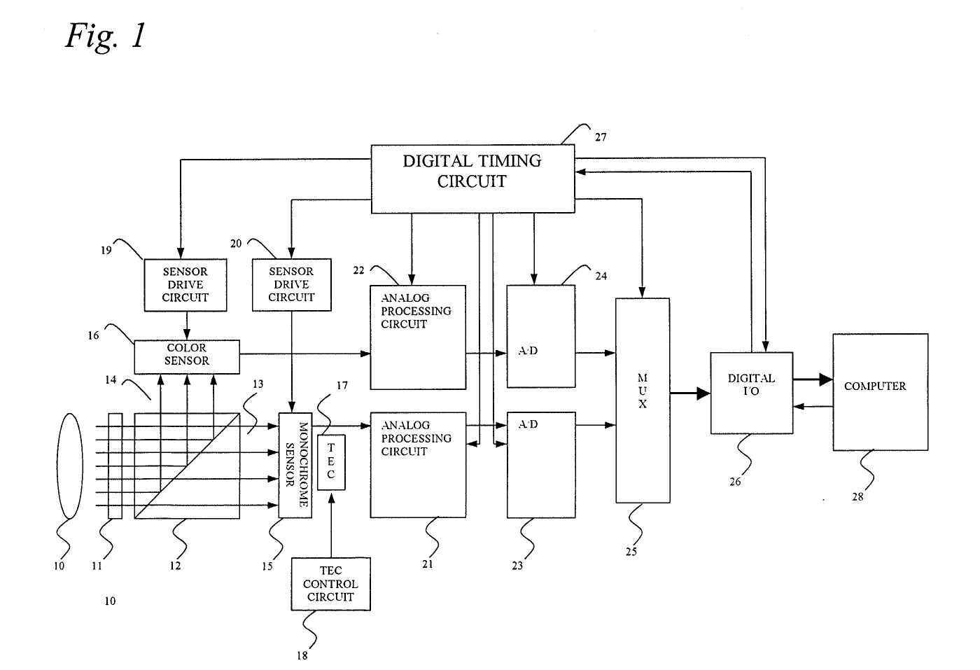

FIG. 1 schematically illustrates a solid-state camera quantitative color image acquisition system in accordance with the invention. Light passing through lens 10 is initially processed through infrared (IR) cutoff filter 11 to remove unwanted infrared light. The IR-attenuated beam output by IR cutoff filter 11 is optically coupled to beam splitter 12, which produces first and second sub-beams 13, 14. First sub-beam 13 is optically coupled to monochrome image sensor 15. Second sub-beam 14 is optically coupled to color image sensor 16. Beam splitter 12 may for example be a non-polarizing broadband type beam splitter having a partially reflecting surface such that the relative intensity of image light which passes from beam splitter 12 to monochrome sensor 15 via first sub-beam 13 is substantially higher than the relative intensity of image light which passes from beam splitter 12 to color sensor 16 via second sub-beam 14. The light intensity ratio of first and second sub-beams 13, 14 depends on the relative sensitivities of monochrome sensor 15 and color sensor 16. With currently available charge-coupled device (CCD) technologies, a suitable light intensity ratio of first and second sub-beams 13, 14 is between about 70:30 and 80:20 (i.e. 70%-80% of the relative intensity of image light output by beam splitter 12 passes to monochrome sensor 15, with the remainder passing to color sensor 16).

Beam splitter 12 may for example be a model XF122/25R beam splitter available from Omega Optical, Inc., Brattleboro, Vt. Color image sensor 16 will typically be a high-resolution CCD sensor such as a model ICX282AQ CCD image sensor available from the Semiconductor Solutions Division of Sony Electronics Inc., San Jose, Calif., but may alternatively be a complementary metal-oxide-semiconductor (CMOS) image sensor. Monochrome image sensor 15 may also be a CMOS image sensor, although a high sensitivity CCD sensor such as a Sony model ICX285AL CCD sensor available from the Semiconductor Solutions Division of Sony Electronics Inc., San Jose, Calif., is preferred for quantitative imaging applications. Monochrome image sensor 15 produces a luminance or monochrome image output signal. Color image sensor 16 produces a chrominance or color image output signal.

For quantitative imaging applications involving either brightfield or low-light conditions, the sensitivity (i.e. the amount of output signal generated in response to a given amount of light energy) of monochrome image sensor 15 should exceed that of color image sensor 16. Sensitivity varies with incident light wavelength-this invention is primarily directed to use with the visible spectrum. Also, the signal-to-noise ratio (i.e. the ratio of the maximum signal relative to the base noise level) of monochrome image sensor 15 should be optimized to facilitate accurate, wavelength-independent light intensity measurement. In such applications color discrimination is a secondary consideration—specimen colors should be identifiable without adversely affecting quantitative performance factors such as sensitivity, resolution and signal-to-noise ratio. Accordingly, color image sensor 16 can be rather “noisy” yet still provide good color discrimination in such applications.

The spatial resolution of color image sensor 16 is preferably but not necessarily greater than that of monochrome sensor 15. Since the optical interface (i.e. lens 10, IR cutoff filter 11 and beam splitter 12) is common to both sensors, the relative spatial resolution is largely determined by pixel size and pixel density, which in turn determines the number of quantified samples per unit area, hence spatial resolution. More particularly, a color image sensor's color filter must represent at least 3 color bands in order to provide a true color image, because optimal color mapping requires at least 3 color pixels for every monochrome pixel. Therefore, color image sensor 16 preferably has at least three times as many pixels as monochrome image sensor 15. One could alternatively use a color image sensor having the same number of or even fewer pixels than the monochrome image sensor, but this would compromise color-to-monochrome pixel mapping capability (i.e. it would be more difficult to accurately represent the true color of every monochrome pixel). As another alternative, color image sensor 16 may be an X3™ image sensor, available from Foveon, Inc. of Santa Clara, Calif. X3™ sensors have three layers of photodetectors positioned to absorb different colors of light at different depths (i.e., one layer records red, another layer records green and the other layer records blue) such that each “pixel” constitutes a stacked group of three subpixels which collectively provide full-color representation.

Monochrome image sensor 15 is driven by monochrome sensor drive circuit 20. Color image sensor 16 is driven by color sensor drive circuit 19. Drive circuits 20, 19 are independently controlled by timing circuit 27 to provide the power, clock and bias voltage signals which sensors 15, 16 require to convert image photons into electronic charges, which move sequentially through the sensors for conversion to sensor output voltage signals in known fashion. Drive circuits 20, 19 are specific to the particular image sensors used, as specified by the sensor manufacturer. Monochrome sensor 15 can be coupled to a thermoelectric cooler (TEC) 17 controlled by a thermoelectric cooler control circuit 18 to allow longer low-light image exposure times by limiting thermal noise or dark current.

Monochrome image sensor 15 produces an electronic output signal which is initially processed by monochrome analog processing circuit 21 as hereinafter explained. The analog output signal produced by monochrome analog processing circuit 21 is converted to digital form by monochrome analog-to-digital (A/D) converter 23. Color image sensor 16 produces an electronic output signal which is initially processed by color analog processing circuit 22 as hereinafter explained. The analog output signal produced by color analog processing circuit 22 is converted to digital form by color A/D converter 24. Analog processing circuits 21, 22 are specific to the particular image sensors used, as specified by the sensor manufacturer. For example, for CCD sensors, typical analog processing circuits such as the Sony CXA2006Q digital camera head amplifier available from the Semiconductor Solutions Division of Sony Electronics Inc., San Jose, Calif. include a pre-amplification stage, a correlated double sampling (CDS) circuit to reduce so-called KTC noise, and a means of controlling signal gain and black level. CMOS sensors typically have integral analog processing circuits.

The signals output by monochrome channel A/D converter 23 and color channel A/D converter 24 are input to multiplexer 25, the output of which is electronically coupled to input/output (I/O) circuit 26. Many suitable A/D converters are commercially available, one example being the ADS805 available from the Burr-Brown Products division of Texas Instruments Incorporated, Dallas, Tex. Multiplexer 25 may be a discrete component such as a Texas Instruments SN74CBT16233 multiplexer/demultiplexer, or may be an integral part of digital timing circuit 27 which may for example be implemented as a programmable logic device in conjunction with a microcontroller. I/O circuit 26 is electronically interfaced to an external computer 28. The type of I/O circuit depends on the desired computer interface; for example, an interface based on the IEEE 1394 standard can be provided by forming I/O circuit 26 of a link layer device such as a PDI1394L21 full duplex 1394 audio/video link layer controller available from the Philips Semiconductors division of Koninklijke Philips Electronics NV in combination with a physical layer device such as a Texas Instruments TSB41AB cable transceiver/arbiter. Timing circuit 27 is electronically coupled to, synchronizes and controls the operation of sensor drive circuits 19, 20; analog processing circuits 21, 22; A/D converters 23, 24; multiplexer 25 and I/O circuit 26. Timing circuit 27 may for example incorporate an EP1K50FC256-3 programmable logic device available from Altera Corporation, San Jose, Calif. in combination with a ATmega103(L) microcontroller available from Atmel Corporation, San Jose, Calif..

In accordance with command signals sent by computer 28 to timing circuit 27 via I/O circuit 26, multiplexer 25 controls application of either the monochrome signal output by monochrome channel A/D converter 23, or the color signal output by color channel A/D converter 24 to I/O circuit 26 and thence to computer 28. More particularly, timing circuit 27 applies suitable clock signals to a selected one of sensor drive circuits 19, 20 to trigger the start and end of an image exposure or integration time interval for whichever of sensors 15, 16 is coupled to the selected sensor drive circuit. Sensors 15, 16 can thus be operated separately as independent imaging devices, allowing maximum flexibility in the design and operation of quantitative image processing algorithms.

For example, one typical quantitative imaging application involves the imaging of DNA material using the well known fluorescent in situ hybridization (FISH) technique to locate specific gene sequences in the DNA material by binding a fluorescent marker to the complementary gene sequence. The FISH technique requires both high sensitivity (to detect the low light fluorescent probes) and color capability (since different color probes may be used simultaneously). Prior art color cameras can be used in FISH imaging of DNA material, but tend to have reduced sensitivity, longer exposure times, reduced resolution or field of view, or higher cost, than can be achieved by this invention.

In operation of the FIG. 1 quantitative imaging system, light from an imaged object is optically coupled through lens 10, which may be any one of a number of lens types including microscope and telescope lenses. IR cutoff filter 11 attenuates the infrared component of the light received through lens 10. This prevents infrared corruption of the color signals, which could otherwise occur since most solid-state image sensors are sensitive to near infrared wavelengths.

The IR-attenuated image light passes through beam splitter 12, which produces first and second sub-beams 13, 14 as aforesaid. Sub-beams 13, 14 each reproduce the original image, less attenuated IR wavelengths. Because the light intensity of first sub-beam 13 exceeds that of second sub-beam 14, monochrome image sensor 15 receives greater image light intensity than color image sensor 16. This facilitates detection of the image signal's color component while minimizing attenuation of the light passed to monochrome sensor 15. This is especially beneficial in low-light quantitative imaging applications, which require maximum sensitivity in order to minimize the duration of the required image exposure time interval.

Monochrome image sensor 15 produces a plurality of (typically greater than one million) monochrome image pixels which are maximally representative of the imaged object due to monochrome image sensor 15's high sensitivity characteristic. Color image sensor 16 produces a plurality of color image pixels. The FIG. 1 camera produces a color image by optically coupling each monochrome image pixel produced by monochrome image sensor 15 to a different group of color image pixels produced by color image sensor 16. Preferably but not essentially, four color pixels are mapped to each monochrome pixel. A 3:1 color:monochrome pixel mapping ratio would also be acceptable, for instance if the image sensors' filters were arrayed as alternating red-green-blue (RGB) stripes. As previously explained, lower color:monochrome pixel mapping ratios can be used, at the expense of sub-optimal color mapping.

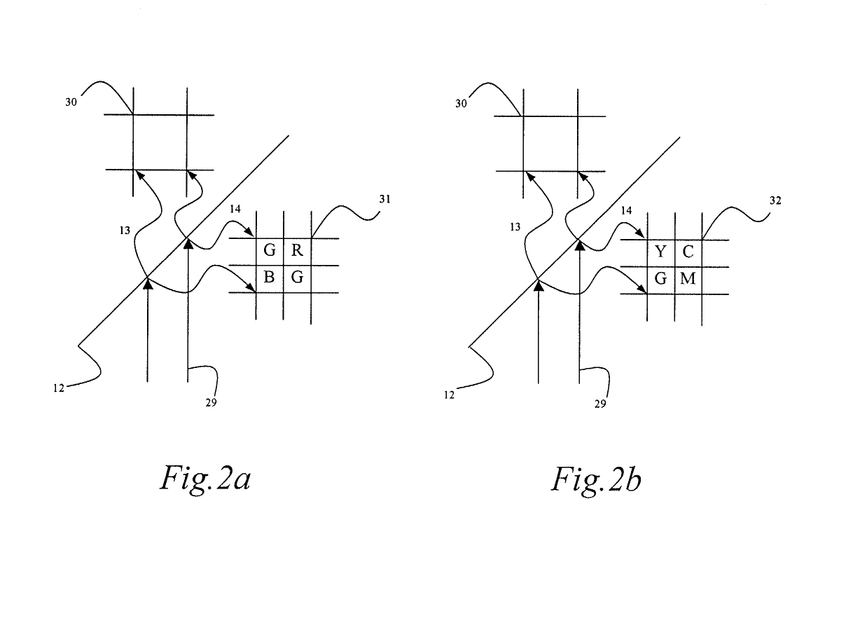

FIG. 2a schematically depicts an embodiment in which beam splitter 12 divides input light 29 into sub-beams 13, 14 to optically associate each monochrome pixel 30 produced by monochrome image sensor 15 with a group 31 of RGB color pixels produced by color image sensor 16. “RGB” refers to a primary color system characterized by pixels having red, green, or blue spectral absorption characteristics. In the FIG. 2a example, group 31 consists of one red (R) pixel, two green (G) pixels, and one blue (B) pixel—the well known Bayer filter pattern in which green is overemphasized because it typically represents the luminance signal or most common color band in the visual world.

FIG. 2b schematically depicts an alternate embodiment in which beam splitter 12 divides input light 29 into sub-beams 13, 14 to optically associate each monochrome pixel 30 with a group 32 of CMYG color pixels produced by color image sensor 16. “CMYG”refers to a complementary color system characterized by pixels having cyan, magenta, yellow, and green spectral absorption characteristics respectively—another common filter pattern. In the FIG. 2b example, group 32 consists of one cyan (C) pixel, one magenta (M) pixel, one yellow (Y) pixel and one green (G) pixel.

Each monochrome pixel 30 produced by monochrome image sensor 15 is aligned with a different color pixel group produced by color image sensor 16. Such alignment is achieved by optical alignment of sensors 15, 16 and by suitable programming of computer 28. Optical alignment of sensors 15, 16 is achieved through high precision opto-mechanical manufacturing techniques which allow sensors 15, 16 to be optically aligned within about 10 pixels over their full imaging areas. Computer 28 is then programmed to compensate for this approximate 10 pixel variation and for slight variations in pixel size between the monochrome and color pixels, for example using a 2-dimensional transformation (mapping) algorithm.

Each one of the different color pixel groups produced by color image sensor 16 includes at least one pixel for each one of the different spectral absorption characteristics color image sensor 16 is capable of producing. For example, in the FIG. 2a RGB color system, color image sensor 16 is capable of producing pixels characterized by one of three different spectral absorption characteristics, namely red, green and blue. Therefore, in the FIG. 2a RGB color system, substantially every monochrome pixel 30 is optically aligned with a different color pixel group 31 which includes at least one red pixel, at least one green pixel and at least one blue pixel. In the FIG. 2b CMYG color system, color image sensor 16 is capable of producing pixels characterized by one of four different spectral absorption characteristics, namely cyan, magenta, green and yellow. Therefore, in the FIG. 2b CMYG color system, substantially every monochrome pixel 30 is optically aligned with a different color pixel group 32 which includes at least one cyan pixel, at least one magenta pixel, at least one green pixel, and at least one yellow pixel. The arrangement of individual color pixels within either of groups 31, 32 does not matter.

In some applications it may be desirable to overlap color pixel groups such that one or more color pixels included in one color pixel group are also included in another color pixel group (or groups). This facilitates, for example, location of a color pixel group which is “closest” to a particular monochrome pixel, according to a predefined criteria representative of “closeness”. As another example, each of the red color pixels in the FIG. 2a RGB color system could be mathematically mapped onto a notional red color plane, with the green and blue pixels respectively being mapped onto notional green and blue color planes, followed by a further mapping to associate each monochrome pixel with the red, green or blue planes or some combination thereof. If the aforementioned Foveon, Inc. X3™ sensor is used as color image sensor 16, then each monochrome pixel can have substantially the same spatial resolution as each color pixel. Recall that each pixel produced by the X3™ sensor constitutes a stacked group of three sub-pixels which collectively provide full-color representation, thus facilitating direct mapping of each monochrome pixel to a corresponding full color pixel.

In summary, the invention facilitates rapid acquisition of low-light color images at reasonable cost, and can be used in a variety of quantitative imaging applications in which high sensitivity and high signal-to-noise ratio are required in combination with a color image component. Sensors 15, 16 can be independently controlled to accommodate high speed high resolution color imaging applications; low-light, quantitative monochrome imaging applications; or a combination of both. For example, sensors 15, 16 can be independently controlled to image different color bands by using monochrome sensor 15 as the primary imaging device; or, to independently vary each sensor's exposure time, readout time, signal gain, etc.

As will be apparent to those skilled in the art in the light of the foregoing disclosure, many alterations and modifications are possible in the practice of this invention without departing from the spirit or scope thereof. For example, image storage and color encoding hardware may optionally be included in the FIG. 1 circuitry, rather than relying on computer 28 to perform these functions. As another example, IR cutoff filter 11 can be located between beam splitter 12 and color sensor 16, thereby allowing monochrome sensor 15 to image the full range of light wavelengths to which it is sensitive. As a further example, beam splitter 12 may be realized as a standard beam splitter cube or as a pellicle (pellicle beam splitters are superior in terms of their reduced susceptibility to chromatic aberrations, spherical aberrations and multiple reflections, but are more fragile and expensive than comparable beam splitter cubes and do not increase working, distance as do glass beam splitter cubes). TEC 17 and its control circuit 18 may be eliminated to reduce cost in certain lower performance applications. The scope of the invention is to be construed in accordance with the substance defined by the following claims.

What is claimed is:

1. A quantitative color image acquisition system, comprising:
(a) a monochrome image sensor optically coupled to receive a first sub-beam having a first light intensity value, said monochrome image sensor producing a first plurality of monochrome image pixels representative of an imaged object;
(b) a color image sensor optically coupled to receive a second sub-beam having a second light intensity value, said color image sensor producing a second plurality of color image pixels representative of said imaged object;
wherein:
(i) said monochrome image sensor has a higher sensitivity than said color image sensor; and,
(ii) said first light intensity value is greater than said second light intensity value.

2. A quantitative color image acquisition system as defined in claim 1, wherein said monochrome image sensor has a high signal-to-noise ratio.

3. A quantitative color image acquisition system as defined in claim 2, further comprising monochrome image sensor control circuitry electronically coupled to said monochrome image sensor, and color image sensor control circuitry electronically coupled to said color image sensor, said monochrome image sensor control circuitry operable independently of said color image sensor control circuitry to selectably independently control each of said monochrome image sensor and said color image sensor.

4. A quantitative color image acquisition system as defined in claim 1, wherein said first light intensity value and said second light intensity value have a ratio between about 70:30 and 80:20.

5. A quantitative color image acquisition system as defined in claim 1, further comprising a beam splitter for splitting an imaged object light beam into said first and second sub-beams.

6. A quantitative color image acquisition system as defined in claim 1, wherein:
(i) each one of said color image pixels has one of a predefined number of spectral absorption characteristics, said spectral absorption characteristics together characterizing a color system;
(ii) said color image pixels are grouped to form a plurality of color pixel groups, each one of said color pixel groups including at least one of each one of said color image pixels having said respective spectral absorption characteristics; and,
(iii) said monochrome image sensor is optically coupled to said color image sensor to associate each one of said monochrome image pixels with a different one of said color pixel groups.

7. A quantitative color imaging method, comprising:
(a) providing a first light sub-beam representative of an imaged object, said first light sub-beam having a first light intensity value;
(b) providing a second light sub-beam representative of an imaged object, said second light sub-beam having a second light intensity value less than said first light intensity value;
(c) processing said first light sub-beam at a first sensitivity to produce a first plurality of monochrome image pixels representative of said imaged object; and,
(d) processing said second light sub-beam at a second sensitivity lower than said first sensitivity to produce a second plurality of color image pixels representative of said imaged object.

8. A quantitative color imaging method as defined in claim 7, further comprising processing said first light sub-beam at maximal signal-to-noise ratio such that said first plurality of monochrome image pixels are maximally representative of said imaged object.

9. A quantitative color imaging method as defined in claim 7, further comprising processing said first light sub-beam selectably independently of said processing of said second light sub-beam.

10. A quantitative color imaging method as defined in claim 7, wherein said first light intensity value and said second light intensity value have a ratio between about 70:30 and 80:20.

11. A quantitative color imaging method as defined in claim 7, wherein said providing of said first and second light sub-beams further comprises splitting an imaged object light beam into said first and second sub-beams.

12. A quantitative color imaging method as defined in claim 7, wherein each one of said color image pixels has one of a predefined number of spectral absorption characteristics, said spectral absorption characteristics together characterizing a primary color system, said method further comprising:
(a) grouping said color image pixels to form a plurality of color pixel groups, each one of said color pixel groups including at least one of each one of said color image pixels having said respective spectral absorption characteristics; and,
(b) associating each one of said monochrome image pixels with a different one of said color pixel groups.

13. A quantitative color imaging method as defined in claim 12, wherein none of said color pixel groups includes one of said color image pixels included in any other one of said color pixel groups.
